(19) United States
(12) Patent Application Publication
(10) Pub. No.: US 2024/0015147 A1
(43) Pub. Date: Jan. 11, 2024

(54) AUTHENTICATOR WITH PASSIVELY-PROVISIONED AUTHENTICATION CREDENTIAL

(71) Applicant: Microsoft Technology Licensing, LLC, Redmond, WA (US)

(72) Inventors: Rajagopalan SRINIVASAN, Redmond, WA (US); Janani MURTHY, Redmond, WA (US); Edward TRAN, Seattle, WA (US); Jeffrey Michael DERSTADT, Sammamish, WA (US); Nishan NASEER, Woodinville, WA (US); Debasish MISHRA, Bellevue, WA (US)

(21) Appl. No.: 18/057,413

(22) Filed: Nov. 21, 2022

Related U.S. Application Data
(60) Provisional application No. 63/359,313, filed on Jul. 8, 2022.

(51) Int. Cl. H04L 9/40

(52) U.S. Cl. CPC H04L 63/083; H04L 51/02

(57) ABSTRACT

An authentication system that supports passive provisioning of an authentication credential includes a widget that controls a user interface and that is embedded in a first inline frame (iframe) of a first webpage and an authenticator that conditionally provides the widget with access to confidential user account information. The authenticator is configured to generate an authentication token and store the authentication token in association with a first session ID associated with a set of inputs received through the user interface and launch a second webpage that includes a second iframe populated with the authentication token, where the second iframe identifies a URL in a same domain as a URL identified by the first iframe embedded within the first webpage. The second webpage further embeds a communication instruction executable to transmit the authentication token from the second iframe embedded within the second webpage to the widget embedded within the first webpage. The authenticator is further configured to receive a verification token and a verification session ID and verify a first match between the verification token and the authentication token and a second match between the verification session ID and the first session ID. In response to the verification, the authenticator grants the widget access to the confidential user account information.

### CROSS-REFERENCE TO RELATED APPLICATIONS

The present application claims priority to provisional application Ser. No. 63/359,313 entitled “Authenticator with Passively-Provisioned Authentication Credential” filed on Jul. 8, 2022, which is hereby incorporated by reference for all that it discloses or teaches.

### BACKGROUND

Two-factor authentication is a desirable safeguard for protecting sensitive account information. However, it is often burdensome to a user to perform multiple actions to log into an online account. For example, the user may have to enter login credentials to receive an authentication and then take further manual action to copy/paste the authentication code from one location to another.

### SUMMARY

According to one implementation, a multi-factor authentication method with passive provisioning of an authentication credential includes receiving, at an authenticator, an account access request from a widget embedded in a first inline frame (iframe) of a first webpage; determining, at the authenticator, a first session ID associated with verification confirmation of a first access credential for a user; generating, at the authenticator, an authentication token and storing the authentication token in association with a first session ID; and launching, by the authenticator, a second webpage. The second webpage includes a second iframe populated with the authentication token, and the second iframe identifies a URL in a same domain as a URL identified by the first iframe embedded within the first webpage. The second webpage further includes a communication instruction executable by the second webpage to transmit the authentication token from the iframe embedded within the second webpage to the widget embedded within the first webpage. The method further provides for receiving, at the authenticator, a verification token and a verification session ID from the widget based at least in part on execution of the communication instruction. In response to verifying a match between the verification token and the authentication token and a match between the verification session ID and the first session ID, the widget is granted access to confidential account information of the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example of 2-factor authentication system that facilitates passive provisioning of a secondary access credential to an authenticator.

FIG. 2 illustrates another example system that implements the same or similar authentication techniques as those disclosed above with respect to FIG. 1.

FIG. 3 illustrates an example sequence diagram of steps that facilitates two factor authentication with silent provisioning of a second access credential.

FIG. 4 illustrates an example schematic of a processing device suitable for implementing aspects of the disclosed technology.

### DETAILED DESCRIPTION

The herein disclosed technology relates to multi-factor authentication with passive provisioning of an authentication credential to reduce the burden on the end user. As used herein “passive provisioning” of an authentication credential implies that the user does not take affirmative action to pass the credential into an authentication system that verifies the credential.

According to one implementation, an authenticator receives an authentication credential through a web browser window that is associated with a detectable session ID. To verify the authentication credential, the authenticator confirms that the received authentication code and associated session ID match a stored a session ID/authentication code pair. The session ID/authentication code pair is, for example, stored in a table when the authentication code is originally generated. If the session ID of the received authentication code matches the session ID stored in association with the same authentication code, this confirms that the secondary authentication credential was created during the same browser session in which the session ID was verified—meaning, one could not nefariously attain the secondary authentication credential and provide it to the authenticator from a different device or from a different web browser session on the same device.

In the above scenario, a typical “active” provisioning of the authentication credential may, for example, occur when a user receives the secondary authentication credential in one location and manual provides (by retyping or copy/paste) the authentication credential into another location However, the herein disclosed technology provides an authentication system with a mechanism for generating the authentication credential, presenting it in a first web location (e.g., a first browser window) and for automatically providing the authentication credential back to itself at a second web location (e.g., a second browser window) without an affirmative user action, such as copy/paste. Provided that the correct authentication credential is provided to the second location and that the session ID associated with the first web location is identical to that of the second web location, the secondary authentication credential can be verified and user account access may be granted.

The herein disclosed systems are described with respect to an exemplary system in which the authentication actions are performed by a chat bot system that provides a user with access to certain account information through a window in which the user is conversing with a chat bot. It may be appreciated, however, that the disclosed 2-factor authentication technique with “passive provisioning” of a secondary credential may be implemented in a variety of different types of systems with web-based architectures similar to that described herein (e.g., in systems that that utilize web browser session ID to verify that the user providing the credential is interacting with a same web session as the web session in which the credential was originally generated).

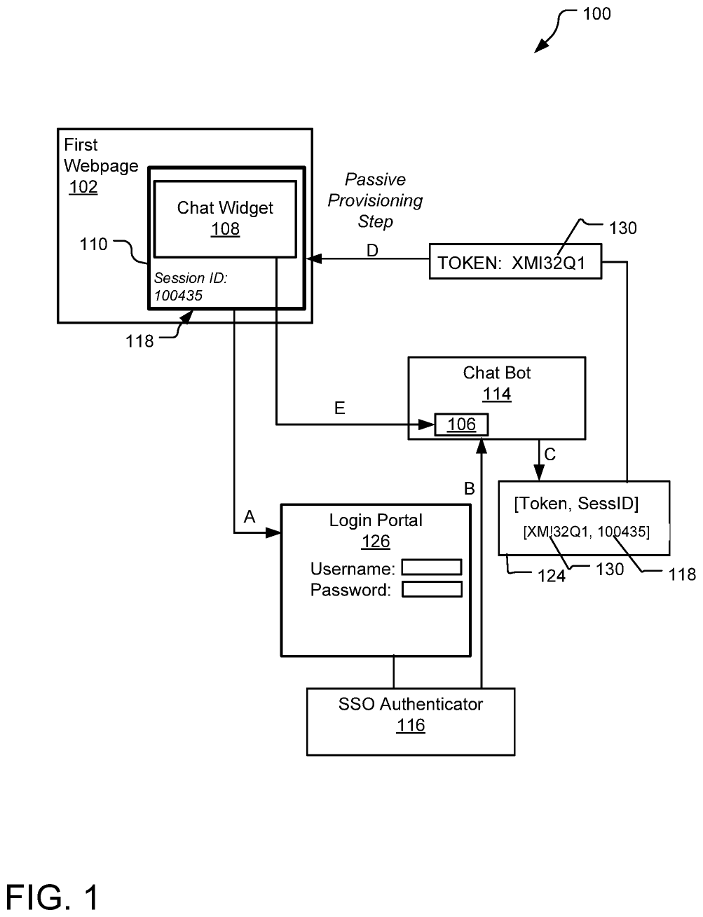

FIG. 1 illustrates an example multi-factor authentication system 100 that facilitates passive provisioning of a secondary access credential to an authenticator 106. In this example, the authenticator 106 is part of a chat bot 114 and is provisioned with an access credential through a window 110 controlled by a chat widget 108 embedded within a first webpage 102. The chat bot 114 performs actions for textually conversing with a user through the chat widget 108. The authenticator 106 provides a safeguard to confidential user account information and conditionally grants the chat bot 114 access to such information responsive to user request through the chat widget 108 and user authentication. Notably, the chat bot 114 is one of a variety of software tools that may be suitable for incorporating aspects of the disclosed technology. In various applications, the authenticator 106 may be incorporated into different types of software tools within platforms that exhibit certain architectural features similar those described herein.

A user provides inputs to the window 110 to interact with the chat bot 114 through the chat widget 108. In certain scenarios, the chat bot 114 is configured to access account information associated with a user account of the user. For example, first webpage 102 may be that of a service provider and the chat widget 108 operating on the first webpage 102 may be designed to communicate with the chat bot 114 to assist the user with questions related to account statements of the user relating to the service offered by the service provider. In one implementation, the user account information is secured by a multi-factor authentication system overseen and implemented, in full or in part, by the authenticator 106. Although the “multi-factor” authentication may provide for authentication of three or more factors, the disclosed example pertain to two-factor authentication where one of the two authentication factors is passively provisioned to the authenticator 106 such that the user does not have to take any affirmative action for the system to be provided with and/or to authenticate the credential.

In one implementation, the chat widget 108 presents a login prompt (e.g., a login button, or other selectable form of input) in the window 110 in response to user input, such as in response to a user question pertaining to the confidential account information (e.g., “what is my account balance? Or “Show me details of my current subscription”). Upon receipt of the user input, the chat widget 108 redirects the user to a login portal 126. For example, the chat widget 108 may open a new window in the user's browser that is managed by a single sign-on (SSO) authenticator 116. In various implementations, the SSO authenticator 116 and login portal 126 may reside within the same domain as the first webpage 102 or within a different domain.

As indicated by arrow “A” in the illustrated implementation, the user provides a primary authentication credential to the login portal 126, such as a username and password. In different implementations, the primary authentication credential may assume different forms and be provisioned in a variety of different ways (e.g., text, imaging, voice). The SSO authenticator 116 verifies the primary authentication credential against a stored credential (e.g., stored username and password). Responsive to successful verification of the primary authentication credential, the SSO authenticator 116 transmits confirmation of the successful verification to the authenticator 106 of the chat bot 114. This communication is represented in FIG. 1 by arrow “B.” In one implementation, the authenticator 106 of the chat bot 114 is passed a URL of the window 110 in addition to the confirmation of successful of first factor authentication. The received URL is stored in association with a unique session ID 118 assigned at the time that the window 110 is launched (e.g., when the first webpage 102 is loaded on a user device).

Given the URL of the window 110 that was provisioned with the initial user input to trigger the above-described first-factor authentication, the chat bot 114 is able to retrieve the session ID 118 assigned to the window 110 that the user is interacting with. The chat bot 114 the generates a secondary authentication credential 130 (e.g., a code/token) and stores this credential in association with the retrieved session ID 118 of the window 110 (e.g., within a table 124), as shown by arrow “C.”

During a next stage of the authentication process, the second authentication credential 130 is passed back to the chat widget 108, as indicated by arrow “D.” Traditionally this step relies on affirmative user action. For example, in systems that do not facilitate the herein disclosed “passive provisioning”, the secondary authentication credential 130 may be presented in a new browser window. In this case, the user copies and pastes the secondary authentication credential 130 back into a user interface of the window 110 where it is received by the chat widget 108. This manual action is burdensome to the user.

Traditionally, the purpose of this copy/paste secondary authentication step is to ensure that the user who initiated the authentication sequence (e.g., provided the username and password) was using the same user device and in the same browser session as the current device and browser session where the confidential information is about the be presented. If, for example, a nefarious actor were to interact with a chat bot, get hold of the signin URL for entering the first authentication credential and trick an unsuspecting user to sign in to that URL, the nefarious actor would still not gain access to the account because the sign in process would not be completed without the user pasting the secondary authentication credential into the chat widget.

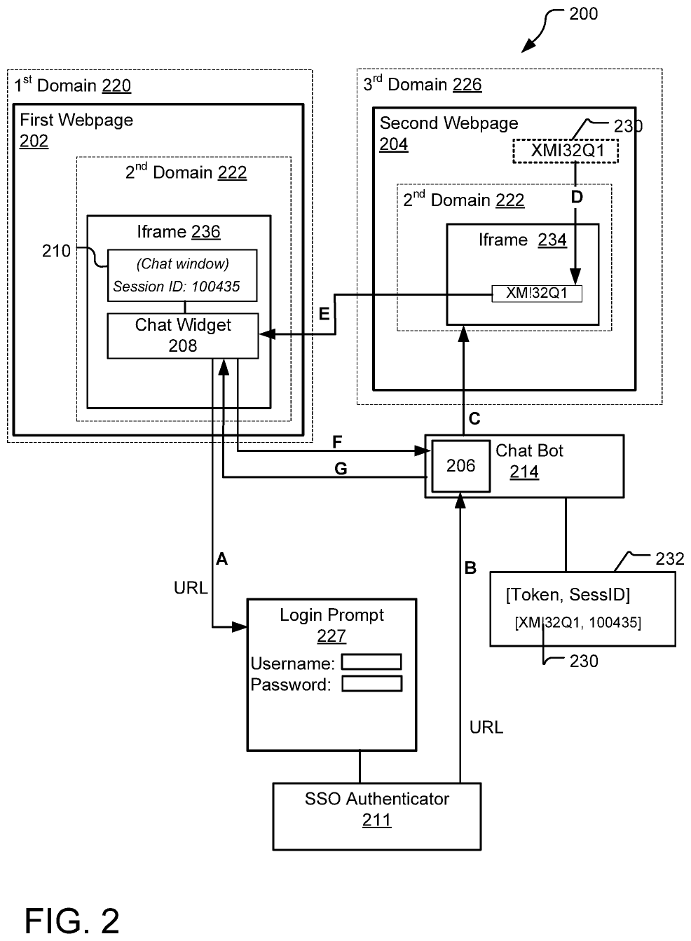

In the herein disclosed authentication process, the authenticator 106 passively provides the chat widget 108 with the secondary authentication credential 130 (as indicated by arrow “D”). The chat widget 108 then passes the secondary authentication credential back to the authenticator 106 (as indicated by arrow “E”) for authentication without affirmative action of the user. These specific actions are described in greater detail with respect to FIG. 2.

In either of the above implementations (active provisioning or passive provisioning of the secondary authentication credential 130), verification of the secondary authentication credential 130 may be performed in a same or substantially similar manner. In one implementation, the chat widget 108 passes the secondary authentication credential 130 back to chat bot 114 (e.g., at arrow E) along with session information that includes or is usable to identify a session ID. For example, the session information may include a URL of the window 110 that is tied to a unique session ID that is accessible to the chat bot 114. The chat bot 114 can then verify that the received secondary authentication credential and its associated session ID match the secondary authentication credential 130 and session ID 118 that are stored as a pair in table 124.

Successful verification of the secondary authentication credential 130 in the above manner serves as confirmation that the secondary authentication credential 130 was created during the same browser session in which primary authentication credential (e.g., user ID, password) was verified. This ensures that both authentication credentials were received as inputs from a same active session (e.g., same session ID, which tied to the user device) with the chat bot. Ultimately, this ensures that the two credentials were provided to the authenticator from the same device and during the same browsing session of the device, thereby ensuring that someone who nefariously obtains one of the two authentication credentials cannot complete a login session initiated on a different user device. Details of the “passive” provisioning step (e.g., at arrow D in FIG. 1) are discussed in greater detail with respect to FIG. 2, below.

FIG. 2 illustrates another example system 200 that implements the same or similar authentication techniques as those disclosed above with respect to FIG. 1. Many of the components of the system 200 perform the same or similar functions as like-named components described above with respect to FIG. 1. However, FIG. 2 illustrates additional system elements that make it possible to passively (without user action) provision an authentication credential generated by a chat bot 214 in association with a first user chat session back into a window of a chat widget 208 to verify that the user is interacting with a same browser session as the browser session used to initiate the authentication sequence, as generally described with respect to FIG. 1.

In FIG. 2, the chat widget 208 is embedded in a first webpage 202 that has a URL associated with a first domain 220. The chat widget 208 is associated with a second domain 222. The chat widget 208 controls a chat window 210 that opens within the first webpage 202. The chat widget 208 relays user inputs provided to the chat window 210 to the chat bot 214 and displays content that the chat bot 214 transmits in response to the user inputs.

In one implementation, the chat bot 214 is hosted by a same domain that hosts the chat widget 208 (e.g., the second domain 222). The chat bot 214 includes an authenticator 206 that safeguards user account information (not shown) in the sense that the chat bot 214 is not permitted to access the user account information or converse with a user about such information except in when authorized by the authenticator 206.

Although the authenticator 206 does perform authentication actions on behalf of the chat bot 214 and may be administratively managed by the same entity, the chat bot is, in one implementation, hosted by a third domain 226 that is separate from the second domain 222 that hosts the chat bot 214 and the chat widget 208.

In an example authentication scenario, a user provides an input to the chat window 210 that triggers a request, to the authenticator 206, to access secure information stored in an account of the user. In response, the authenticator 206 directs the user to a login prompt 227 in the chat window 210, as indicated by arrow “A”. For example, the authenticator 206 instructs the chat widget 208 to execute a redirect (e.g., to a third party login website such as login.microsoft.com), which causes the login prompt 227 to be presented in the chat window 210. In various implementations, the login prompt 227 may assume different forms and/or open in different locations.

In one implementation, the login prompt 227 opens in a new tab of the user's browser. In another implementation, the login prompt 227 populates within the chat window 210 or within the first webpage 202. The user provides a primary authentication credential to the login prompt 227, such as by typing a username and password, or performing other action such as by initiating facial or fingerprint, voice command, etc. A single sign-on (SSO) authenticator 211 verifies the primary authentication credential, such as by comparing the received credential to a stored credential. In various implementations, the SSO authenticator 211 may be hosted in different locations (e.g., within the first domain 220, the second domain 222, or a separate domain entirely).

In the system 200, the chat window 210 and the chat widget 208 are defined within an inline frame (“iframe”) embedded in the first webpage 202. An iframe is an HTML element that loads one HTML page within another HTML page. In illustrated scenario, the first webpage 202 is of a first domain 220 (e.g., of a service provider) and the iframe 236 loads a URL in the chat window 210 that is of the second domain 222 (e.g., a domain used by the chat widget 208 and chat bot 214). The URL of the chat window 210 is usable, by the chat bot 214, to identify a unique session ID for the chat session occurring within the chat window 210. For example, a new session ID may be assigned each time the chat window 210 is launched. This session ID may be included within or identifiable from the URL of the chat window 210.

When the user initializes the authentication process, such as by clicking a “login” prompt presented in the chat window 210, the URL of the chat window 210 is passed to the authenticator 206 of the chat bot 214, as indicated by arrow “B.” Consequently, the chat bot 214 is aware of the URL of the chat window 210 before authentication is performed.

When the SSO authenticator 211 successfully authenticates the primary authentication credential, the SSO authenticator 211 transmits confirmation of the authentication to the chat bot 214, as shown by arrow B. In one implementation, the URL of the chat window 210 is passed from the chat window 210 to the SSO authenticator 211 and to the chat bot 214, as shown in FIG. 2 such that the chat bot 214 receives the URL of the chat window 210 in association with a confirmation of user verification by the SSO authenticator 211. From this URL, the chat bot 214 is able to determine a unique session ID identifying the chat session that initialized the authentication process. In response to receiving the verification from the SSO authenticator 211, the chat bot 214 generates a secondary authentication credential 230 (e.g., a token), and stores the secondary authentication credential 230 in association with the session ID of the active chat session, as shown in table 232.

The user is then redirected from the login prompt 227 to a second webpage 204, as indicated by arrow C. In various implementations, this is implemented by one or a series of redirects. For example, the SSO authenticator 211 transmits the confirmation to the authenticator 206 which, in turn, opens the second webpage 204 in a new window of the user's browser with the second webpage 204. Since the authenticator uses a third domain 226 to display information, the second webpage 204 is in the third domain 226.

The authenticator 206 presents the secondary authentication credential 230 in the second webpage 204 and also embeds within the second webpage 204 a communication instruction that provides for passively communicating the secondary authentication credential 230 to the chat window 210, as is discussed further below.

Due to the fact that the second webpage 204 is in a different domain than the chat window 210, traditional web communications do not permit the automatic transmission of the second authentication credential from the second webpage 204 in the third domain 226 to the chat window 210 in the second domain 222. This dilemma is solved in the present implementation by way of another iframe 234 that is embedded within the second webpage 204. The iframe 234 loads the URL of the iframe 236 (e.g., the URL that is passed to the chat bot 214 when the authentication sequence is initiated).

In one implementation, the secondary authentication credential 230 is rendered within the second webpage 204 and then passively communicated (without user input) from this location to the chat widget 208 in a 2-step process. During a first communication step indicated by arrow D, the second webpage 204 execute an “iframe populate” instruction generated by the chat bot 214 that causes the secondary authentication credential 230 to be passed from the second webpage 204 to the iframe 234. Although the iframe 234 has a URL that is of a different domain than that of the second webpage 204, this communication is permitted because the iframe 234 and the second webpage 204 are defined to have a parent-child relationship that leverages a technique known as cross-frame communication. Consequently, the second webpage 204 (the parent) can pass information to the iframe 234 (the child).

During a second communication step of the above process, indicated by arrow E, the second webpage 204 executes a communication instruction (e.g., an HTML executable generated by the chat bot 214), that causes the secondary authentication credential 230 to be passed from the iframe 234 within the second webpage 204 to the iframe 326 that includes the chat window 210. Because the iframes 234 and 236 share a same domain, this communication is supported by a “Broadcast Channel API,” which is an executable function that publishes and thereby facilitates the exchange of information between different webpages of a same domain.

Using the Broadcast Channel API, the secondary authentication credential 230 is broadcast to other entities residing in the second domain 222 that are subscribed to this broadcast channel. Since the chat widget 208 within the iframe 236 is in the second domain 222 and subscribed to the Broadcast Channel API for this domain, the chat widget 208 receives the secondary authentication credential 230 from the iframe 234 of the second webpage 204.

When the chat widget 208 obtains the secondary authentication credential 230 through the broadcast channel, the chat widget 208 transmits (e.g., at arrow “F”) the secondary authentication credential 230 back to the authenticator 206 along with the session ID of the iframe 234 identifying the active chat session within the iframe 234.

In the remaining description of FIG. 2, the above-described authentication credential and session ID received at arrow “F” are referred to as a “verification token” and “verification session ID.” The verification session ID is used by the authenticator 206 to pull the appropriate line in the table 232. If the received verification token matches the secondary authentication credential 230 previously stored in association with the verification session ID the second authentication factor is verified. In this case, the authenticator 206 accesses the user account and/and provides the chat widget 208 with access to account information, as indicated by arrow “G.” The chat widget 208, in turn, presents user account information in the chat window 210 and can assist the user with questions related to the user account information.

This verification ensures that both credentials in the 2-factor authentication process were received in association with a same session ID and not entered from separate devices and/or alternative (e.g., old) chat sessions of the same user, such as a session improperly terminated. At the same time, the passive provisioning of the secondary authentication credential 230 to the chat window 210 reduces the manual effort of the user, improving the user experience when interacting with the chat bot 214.

In one implementation, the second webpage 204 remains open temporarily (e.g., for a fraction of a second) and then is closed by the chat bot 214 immediately following execution of the communication instruction that broadcasts the authentication token to the chat widget 208. The opening and closing of the second webpage 204 may occur so quickly that the user is unlikely to notice the second webpage 204 at all. For example, the second webpage 204 being opened and closed may appear like a quick flicker or occur so quickly that it is not detectable to the human eye.

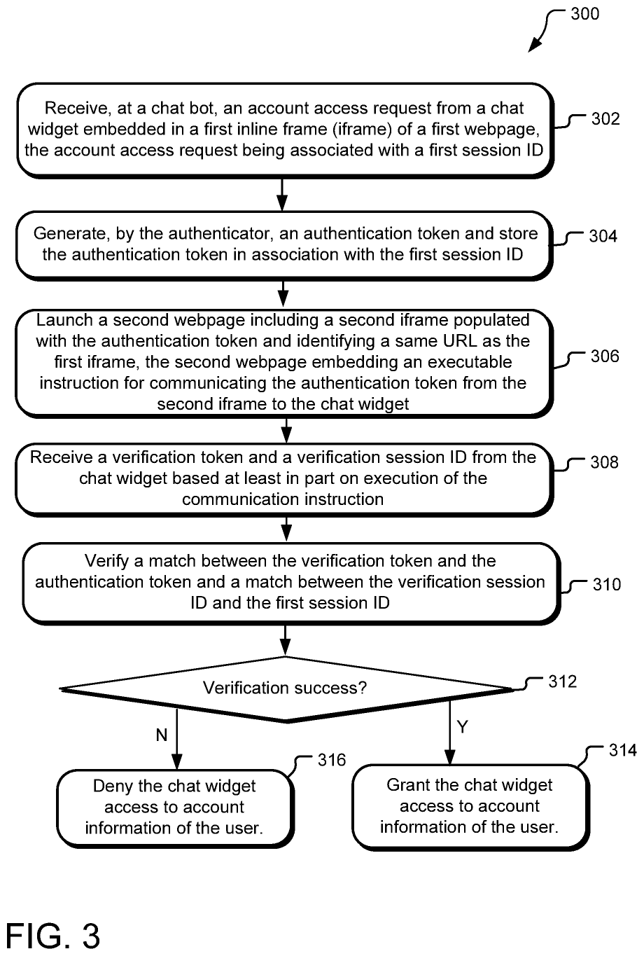

FIG. 3 illustrates example operations 300 for generating, passively provisioning, and verifying an authentication credential to ensure that a chat session potentially receiving confidential user information following a user authentication sequence is also the chat session (e.g., on the same user device same browser session) that was used to initiate the authentication sequence.

A receiving operation 302 receives, at an authenticator, an account access request from a chat widget embedded in a first inline frame of a first webpage (a “first iframe”). The chat widget facilitates communications between the user and a chat bot. The account access request may assume a variety of different forms but is, in general, a request pertaining to confidential user account information. For example, the user may provide an input to a user interface requesting to a current account balance, subscription details, or other types of confidential user information. This input is received by the chat widget, and the chat widget, in turn, conveys an access requested to the authenticator of the chat bot. The authenticator initializes an authentication sequence.

During the aforementioned authentication sequence, an authentication credential generation operation 304 generates, at the authenticator, an authentication token and stores the authentication token in association with a first session ID that uniquely identifies the chat session associated with the account access request. In one implementation, the chat widget passes the first session ID to the authenticator along with the account access request.

In an implementation where the authentication sequence is a multi-factor authentication sequence, the user may be prompted for a first access credential (e.g., either by the chat widget or by other service provider following a redirect initialized by the chat widget). In this implementation, the authentication credential generation operation 304 is performed in response to the verification of the first access credential.

Following generation of the authentication token, the authenticator performs a launching operation 306 that launches a second webpage. In one implementation, the first frame identifies a URL that is identical to a URL identified by the second iframe. The second webpage populates the second iframe with the authentication token. For example, the second webpage may execute an embedded instruction that invokes cross-frame communication to pass the authentication token into the second iframe. The second webpage also includes a communication instruction that, when executed, communicates the authentication token from the second iframe along a secure channel that other webpages of the same domain have access to. Since the chat widget is embedded in the first iframe and the first and second iframes are both defined by URLs in the same domain (e.g., the same URL), the chat widget is able to receive the authentication token when it is communicated in this way.

A receiving operation 308 provides for receiving a verification token and a verification session ID from the chat widget based at least in part on the execution of the communication instruction. In a successful instance of authentication, the verification token matches the authentication token. For example, the communication instruction broadcasts the authentication token to an instance of widget associated with the URL identified in the second iframe. Responsive to receiving this broadcast, this instance of the widget provides the authentication token that it has received (“the verification token”) back to the authenticator along with a session ID of its current session (“the verification session ID”). If the authentication sequence was initiated in the same user session as the current session, the token/session pair consisting of the verification token and the verification session ID will match that of a previously-saved token/session pair consisting of the first session ID and the authentication token.

A verification operation 310 verifies that (1) the verification token matches the authentication token and (2) that the verification session ID matches the first session ID. A determination operation 312 determines whether the verification operation 310 has succeeded or failed. In cases where the verification succeeds, an access grant operation 314 grants the chat widget access to account information of the user. In cases where the verification fails, a deny access operation 316 denies the chat widget access to the account information of the user.

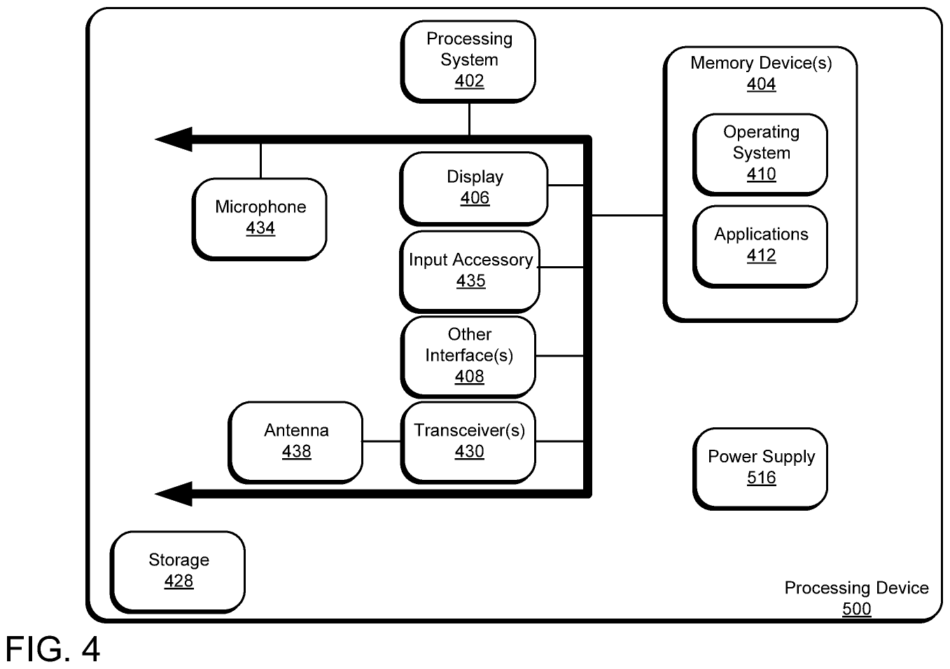

FIG. 4 illustrates an example schematic of a processing device 400 suitable for implementing aspects of the disclosed technology. The processing device 400 includes a processing system 402, memory device(s) 404, a display 406, and other interfaces 408 (e.g., buttons). The processing system 402 includes one or more processors (CPUs, GPUs, etc.).

The memory 404 generally includes both volatile memory (e.g., RAM) and non-volatile memory (e.g., flash memory). An operating system 410 may reside in the memory 404 and be executed by the processing system 402. A chat widget and/or a chat bot may also be stored in the memory 404 or in distributed memory of multiple different storage devices.

One or more applications 412 (e.g., the chat widget 108, chat bot 114) are loaded in the memory 404 and executed on the operating system 410 by the processing system 402. The applications 412 may receive inputs from one another as well as from various input local devices such as a microphone 434, and an input accessory 435 (e.g., keypad, mouse, stylus, touchpad, gamepad, joystick).

Additionally, the applications 412 may receive input from one or more remote devices, such as remotely-located smart devices, by communicating with such devices over a wired or wireless network using more communication transceivers 430 and an antenna 438 to provide network connectivity (e.g., a mobile phone network, Wi-Fi®, Bluetooth®). The processing device 400 may also include one or more storage devices 428 (e.g., non-volatile storage). Other configurations may also be employed. The processing device 400 further includes a power supply 416, which is powered by one or more batteries or other power sources and which provides power to other components of the processing device 400. The power supply 416 may also be connected to an external power source (not shown) that overrides or recharges the built-in batteries or other power sources.

The processing device 400 may include a variety of tangible computer-readable storage media and intangible computer-readable communication signals. Tangible computer-readable storage can be embodied by any available media that can be accessed by the processing device 400 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 400. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, intangible communication signals include wired media such as a wired network or direct-wired connection, and wireless media such as acoustic, RF, infrared, and other wireless media.

Some implementations may comprise an article of manufacture. An article of manufacture may comprise a tangible storage medium (a memory device) to store logic. Examples of a storage medium include one or more types of processor-readable storage media capable of storing electronic data, including volatile memory or non-volatile memory, removable or non-removable memory, erasable or non-erasable memory, writeable or re-writeable memory, and so forth. Examples of the logic include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture stores executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

(A1) According to a first aspect, some implementations include a method for passive provisioning of an authentication token to authenticate a user. The method includes receiving, at an authenticator, an account access request that is associated with a user and from a widget embedded in a first inline frame (iframe) of a first webpage. The method further includes determining, at the authenticator, a first session ID associated with verification confirmation of a first access credential; and generating, at the authenticator, an authentication token and storing the authentication token in association with a first session ID. The method further provides for launching, by the authenticator, a second webpage including a second iframe populated with the authentication token and communication instruction executable by the second webpage to transmit the authentication token from the iframe embedded within the second webpage to the widget embedded within the first webpage. The second iframe identifies a URL in a same domain as a URL identified by the first iframe embedded within the first webpage. The method further includes receiving, at the authenticator, a verification token and a verification session ID from the widget based at least in part on execution of the communication instruction; and
in response to verifying a match between the verification token and the authentication token and a match between the verification session ID and the first session ID, granting the widget access to confidential account information of the user.

The method of A1 is advantageous because it allows for multi-factor authentication without the user needing to perform an affirmative action to supply a secondary access credential.

(A2) In some implementations of A1, execution of the communication instruction broadcasts the authentication token along a communication channel that the widget is subscribed to. (A3) In some implementations of A1 and A2, the second iframe is populated with the authentication token by using cross-frame communication. The methods of A2 and A3 are advantageous because they work in combination to provide a secure mechanism for automatically conveying the secondary access credential to the widget that would otherwise have to be performed manually by the user.

(A4) In some implementations of A1-A3, the second webpage is of a first domain that is different than a second domain of the first iframe and the second iframe. (A5) In still other implementations of A1-A4, the first webpage is of a third domain different than the first domain and the second domain.

(A6) In yet still other implementations of A1-A5, the widget is a chat widget and the authenticator is part of a chat bot that communicates with the chat widget to push content to a user interface defined by the first iframe. In this system, the methods of A1-A5 provide a multi-factor authentication mechanism to prevent the chat bot from accessing sensitive user information except in scenarios where all factors of the multi-factor authentication are verified.

(A7) In still other implementations of A1-A6, the first session ID uniquely identifies a chat session supported by the chat widget. Associating the authentication token with the first session ID facilitates a security check that ensures the user provided both access credentials from a same user device and in association with the same chat session. In another aspect, some implementations include a computing system for performing multi-factor authentication with a passively-provisioned access credential. The computing system includes hardware logic circuitry that is configured to perform any of the methods described herein (e.g., methods A1-A7).

In yet still another aspect, some implementations include a computer-readable storage medium for storing computer-readable instructions. The computer-readable instructions, when executed by one or more hardware processors, perform any of the methods described herein (e.g., methods A1-A7).

According to another aspect, some implementations include a system for passive provisioning of an authentication token to authenticate a user. The system include a means for receiving, at an authenticator, an account access request that is associated with a user and from a widget embedded in a first inline frame (iframe) of a first webpage. The system further includes a means for determining, at the authenticator, a first session ID associated with verification confirmation of a first access credential and a means for generating, at the authenticator, an authentication token and storing the authentication token in association with a first session ID. The system still further includes a means for launching, by the authenticator, a second webpage including a second iframe populated with the authentication token and communication instruction executable by the second webpage to transmit the authentication token from the iframe embedded within the second webpage to the widget embedded within the first webpage. The second iframe identifies a URL in a same domain as a URL identified by the first iframe embedded within the first webpage. The system still further includes a means for receiving, at the authenticator, a verification token and a verification session ID from the widget based at least in part on execution of the communication instruction as well as a means for verifying a match between the verification token and the authentication token, a means for verifying a match between the verification session ID and the first session ID, and a means for granting the widget access to confidential account information of the user.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of example implementations.

What is claimed is:

1. An authentication system with passive provisioning of an authentication token to authenticate a user, the authentication system comprising:
a widget that controls a user interface and that is embedded in a first inline frame (iframe) of a first webpage; and
an authenticator that conditionally provides the widget with access to confidential user account information, the authenticator configured to:
generate an authentication token and store the authentication token in association with a first session ID associated with a set of inputs received through the user interface;
launch a second webpage, the second webpage including:
a second iframe populated with the authentication token, the second iframe identifying a second URL in a same domain as a first URL identified by the first iframe embedded within the first webpage;
a communication instruction executable by the second webpage to transmit the authentication token from the second iframe embedded within the second webpage to the widget embedded within the first webpage;
receive a verification token and a verification session ID from the widget; and
in response to verifying a first match between the verification token and the authentication token and a second match between the verification session ID and the first session ID, provide the widget with access to the confidential user account information.

2. The authentication system of claim 1, wherein the communication instruction broadcasts the authentication token along a communication channel that the widget is subscribed to.

3. The authentication system of claim 1, wherein the authentication token is a secondary authentication credential and wherein the authenticator generates the authentication token responsive to verification of a first authentication credential.

4. The authentication system of claim 1, wherein the authenticator populates the iframe embedded within the second webpage with the authentication token by using cross-frame communication.

5. The authentication system of claim 1, wherein the second webpage is of a first domain that is different than a second domain of the widget and a third domain of the first webpage.

6. The authentication system of claim 1, wherein the widget is a chat widget and the authenticator is included in a chat bot that communicates with the chat widget to provide content to the user interface.

7. The authentication system of claim 6, wherein the first session ID uniquely identifies a chat session supported by the chat widget.

8. The authentication system of claim 1, wherein the second webpage is automatically closed following execution of the communication instruction.

9. A method for passive provisioning of an authentication token to authenticate a user, the method comprising:
receiving, at an authenticator, an account access request from a widget embedded in a first inline frame (iframe) of a first webpage, the account access request being associated with a user;
determining, at the authenticator, a first session ID associated with verification confirmation of a first access credential;
generating, at the authenticator, an authentication token and storing the authentication token in association with a first session ID;
launching, by the authenticator, a second webpage including:
a second iframe populated with the authentication token, the second iframe identifying a URL in a same domain as a URL identified by the first iframe embedded within the first webpage; and
a communication instruction executable by the second webpage to transmit the authentication token from the iframe embedded within the second webpage to the widget embedded within the first webpage;
receiving, at the authenticator, a verification token and a verification session ID from the widget based at least in part on execution of the communication instruction; and
in response to verifying a match between the verification token and the authentication token and a match between the verification session ID and the first session ID, granting the widget access to confidential account information of the user.

10. The method of claim 9, wherein execution of the communication instruction broadcasts the authentication token along a communication channel that the widget is subscribed to.

11. The method of claim 9, wherein the second iframe is populated with the authentication token by using cross-frame communication.

12. The method of claim 9, wherein the second webpage is of a first domain that is different than a second domain of the first iframe and the second iframe.

13. The method of claim 12, wherein the first webpage is of a third domain different than the first domain and the second domain.

14. The method of claim 9, wherein the widget is a chat widget and the authenticator is part of a chat bot that communicates with the chat widget to push content to a user interface defined by the first iframe.

15. The method of claim 14, wherein the first session ID uniquely identifies a chat session supported by the chat widget.

16. One or more tangible computer readable storage media encoding computer-executable instructions for executing a computer process for user authentication, the computer process comprising:
receiving, at an authenticator, an account access request from a widget embedded in a first inline frame (iframe) of a first webpage;
in response to receipt of the account access request, generating, at the authenticator, an authentication token and storing the authentication token in association with a first session ID;
launching, by the authenticator, a second webpage including:
a second iframe populated with the authentication token, the second iframe identifying a second URL in a same domain as a first URL identified by the first iframe embedded within the first webpage; and
a communication instruction executable by the second webpage to transmit the authentication token from the iframe embedded within the second webpage to the widget embedded within the first webpage;
receiving, at the authenticator, a verification token and a verification session ID from the widget based at least in part on execution of the communication instruction; and
in response to verifying a match between the verification token and the authentication token and a match between the verification session ID and the first session ID, granting the widget access to confidential account information of the user.

17. The one or more tangible computer-readable storage media of claim 16, wherein execution of the communication instruction broadcasts the authentication token along a communication channel that the widget is subscribed to.

18. The one or more tangible computer-readable storage media of claim 16, wherein the authentication token is a secondary authentication credential generated and stored by the authenticator responsive to confirmation of successful verification of a first authentication credential associated with the user.

19. The one or more tangible computer-readable storage media of claim 16, wherein the second webpage is of a first domain that is different than a second domain shared by the first iframe and the second iframe and different from a third domain of the first webpage.

20. The one or more tangible computer-readable storage media of claim 16, wherein the second iframe is populated with the authentication token by using cross-frame communication.
